(19) United States
(12) Patent Application Publication
(10) Pub. No.: US 2026/0161047 A1
(43) Pub. Date: Jun. 11, 2026

(54) OPTICAL ELEMENT DRIVING MECHANISM

(71) Applicant: TDK TAIWAN CORP., Taoyuan City (TW)

(72) Inventors: Ying-Jen WANG, Taoyuan City (TW); Yi-Ho CHEN, Taoyuan City (TW); Chia-Che WU, Taoyuan City (TW); Ya-Hsiu WU, Taoyuan City (TW)

(21) Appl. No.: 19/320,529

(22) Filed: Sep. 5, 2025

Related U.S. Application Data
(60) Provisional application No. 63/694,389, filed on Sep. 13, 2024.

(51) Int. Cl. G03B 5/00; G02B 7/09; G03B 13/36

(52) U.S. Cl. CPC G03B 5/00; G02B 7/09; G03B 13/36; G03B 2205/0069

(57) ABSTRACT

An optical element driving mechanism is provided. The optical element driving mechanism includes a fixed portion, a movable assembly, and a driving assembly. The movable assembly is movably connected to the fixed portion. The driving assembly is used for driving the movable assembly to move relative to the fixed portion.

### CROSS REFERENCE TO RELATED APPLICATIONS

This application claims the benefit of U.S. provisional application No. 63/694,389, filed Sep. 13, 2024, the entirety of which is incorporated by reference herein.

### TECHNICAL FIELD

The present disclosure relates to an optical element driving mechanism.

### BACKGROUND

As technology has developed, it has become more common to include image-capturing and video-recording functions into many types of modern electronic devices, such as smartphones and digital cameras. These electronic devices are used more and more often, and new models have been developed that are convenient, thin, and lightweight, offering more choice to consumers.

Electronic devices that have image-capturing or video-recording functions normally include a driving mechanism to drive an optical element (such as a lens) to move along its optical axis, thereby achieving auto focus (AF) or optical image stabilization (OIS). Light may pass through the optical element and may form an image on an optical sensor. However, the trend in modern mobile devices is to have a smaller size and a higher durability. As a result, how to effectively reduce the size of the optical system and how to increase its durability has become an important issue.

### BRIEF SUMMARY

An optical element driving mechanism is provided. The optical element driving mechanism includes a fixed portion, a movable assembly, and a driving assembly. The movable assembly is movably connected to the fixed portion. The driving assembly is used for driving the movable assembly to move relative to the fixed portion.

In some embodiments, the driving assembly is disposed between the fixed portion and the movable assembly. The fixed portion includes a case and a bottom arranged along a main axis. The movable assembly includes a first movable portion movably connected to the fixed portion and including a first opening. When viewed along the main axis, the first opening includes a first opening side having a linear shape and extending along a first direction, a second opening side having a linear shape and extending along a second direction, a third opening side having a linear shape and extending along a third direction, and a fourth opening side having a linear shape and extending along a fourth direction. The first direction is different from the second direction. The first direction is parallel to the third direction. The first direction is different from the fourth direction. The second direction is parallel to the fourth direction. The main axis passes through a center of the optical element driving mechanism. In a top view, a first reference axis and a second reference axis intersect at the center. The first reference axis extends along a first axis. The second reference axis extends along a second axis. The first axis and the second axis are perpendicular. In the top view, the first reference axis and the second reference axis divide the top view into four quadrants, which in counterclockwise order are a first quadrant, a second quadrant, a third quadrant, and a fourth quadrant. The first opening side is located in the first quadrant. The second opening side is located in the second quadrant. The third opening side is located in the third quadrant. The fourth opening side is located in the fourth quadrant. When viewed along the main axis, the first reference axis and the second reference axis do not pass through the first opening side, the second opening side, the third opening side, or the fourth opening side.

In some embodiments, the movable assembly further includes a second movable portion movably connected to the fixed portion and including a second opening. The optical element driving mechanism further includes: a connecting assembly disposed between the first movable portion and the second movable portion; a first connecting portion disposed on the fixed portion; and a second connecting portion disposed on the fixed portion. The connecting assembly includes: a first connecting element; a second connecting element disposed on the first connecting element and movably connected to the first movable portion; and a third connecting element disposed on the first connecting element and movably connected to the second movable portion. The first direction is perpendicular to the second direction. The first direction is perpendicular to the fourth direction. The first connecting portion extends along the main axis. The second connecting portion extends along the main axis. The bottom includes a side, and the first connecting portion and the second connecting portion are arranged along a direction parallel to the side. The first movable portion has a plurality of recesses located on the first opening side, the second opening side, the third opening side, and the fourth opening side. Each of the recesses includes a first portion extending along the main axis. When viewed along the main axis, the first portion is exposed to the first movable portion. The driving assembly includes: a first coil disposed between the fixed portion and the first movable portion; a first magnetic element disposed between the fixed portion and the first movable portion corresponding to the first coil; a second coil disposed between the fixed portion and the first movable portion; a second magnetic element disposed between the fixed portion and the first movable portion corresponding to the second coil; a third coil disposed between the fixed portion and the first movable portion; and a third magnetic element disposed between the fixed portion and the first movable portion corresponding to the third coil. The first coil and the second coil are located on different sides of the first movable portion. The first coil and the third coil are located on different sides of the first movable portion. The second coil and the third coil are located on the same side of the first movable portion.

### BRIEF DESCRIPTION OF THE DRAWINGS

Aspects of the present disclosure are best understood from the following detailed description when read with the accompanying figures. It should be noted that, in accordance with the standard practice in the industry, various features are not drawn to scale. In fact, the dimensions of the various features may be arbitrarily increased or reduced for clarity of discussion.

FIG. 1A is a schematic view of the optical element driving mechanism.

FIG. 1B is an exploded view of the optical element driving mechanism.

FIG. 1C is a top view of the optical element driving mechanism.

FIG. 2A is a cross-sectional view taken along line A-A of FIG. 1C.

FIG. 2B is a cross-sectional view taken along line B-B of FIG. 1C.

FIG. 2C is a cross-sectional view taken along line C-C of FIG. 1C.

FIG. 2D is a cross-sectional view taken along line D-D of FIG. 1C.

FIG. 2E is an enlarged view of a region of FIG. 2D.

FIGS. 3A, 3B, and 3C are top views of some elements of the optical element driving mechanism.

FIG. 4A is a schematic view of the optical element driving mechanism according to other embodiments of the present disclosure.

FIG. 4B is an exploded view of the optical element driving mechanism.

FIG. 4C is a top view of the optical element driving mechanism.

FIG. 4D is a cross-sectional view taken along line E-E of FIG. 4C.

FIG. 4E is a cross-sectional view taken along line F-F of FIG. 4C.

FIG. 5A is a schematic view of some elements of the optical element driving mechanism.

FIG. 5B is a top view of some elements of the optical element driving mechanism.

FIG. 6A is a schematic view of some elements of the optical element driving mechanism.

FIG. 6B is a top view of some elements of the optical element driving mechanism.

FIG. 7A is a schematic view of the connecting assembly.

FIG. 7B is a top view of the connecting assembly.

### DETAILED DESCRIPTION

The following disclosure provides many different embodiments, or examples, for implementing different features of the provided subject matter. Specific examples of elements and arrangements are described below to simplify the present disclosure. These are, of course, merely examples and are not intended to be limiting. For example, in some embodiments, the formation of a first feature over or on a second feature in the description that follows may include embodiments in which the first and second features are in direct contact, and may further include embodiments in which additional features may be disposed between the first and second features, such that the first and second features may not be in direct contact.

In addition, the present disclosure may repeat reference numerals and/or letters in the various examples. This repetition is for the purpose of simplicity and clarity and does not in itself dictate a relationship between the various embodiments and/or configurations discussed. Moreover, the formation of a feature on, connected to, and/or coupled to another feature in the present disclosure that follows may include embodiments in which the features are in direct contact, and may further include embodiments in which additional features may be disposed interposing the features, such that the features may not be in direct contact. In addition, spatially relative terms, for example, “vertical,” “above,” “over,” “below,”, “bottom,” etc. as well as derivatives thereof (e.g., “downwardly,” “upwardly,” etc.) are used in the present disclosure for ease of description of one feature's relationship to another feature. The spatially relative terms are intended to cover different orientations of the device, including the features.

Unless defined otherwise, all technical and scientific terms used herein have the same meaning as commonly understood by one of ordinary skill in the art to which this disclosure belongs. It should be appreciated that each term, which is defined in a commonly used dictionary, should be interpreted as having a meaning conforming to the relative skills and the background or the context of the present disclosure, and should not be interpreted in an idealized or overly formal manner unless defined otherwise.

Use of ordinal terms such as “first”, “second”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

In addition, in some embodiments of the present disclosure, terms concerning attachments, coupling and the like, such as “connected” and “interconnected”, refer to a relationship wherein structures are secured or attached to one another either directly or indirectly through intervening structures, as well as both movable or rigid attachments or relationships, unless expressly described otherwise.

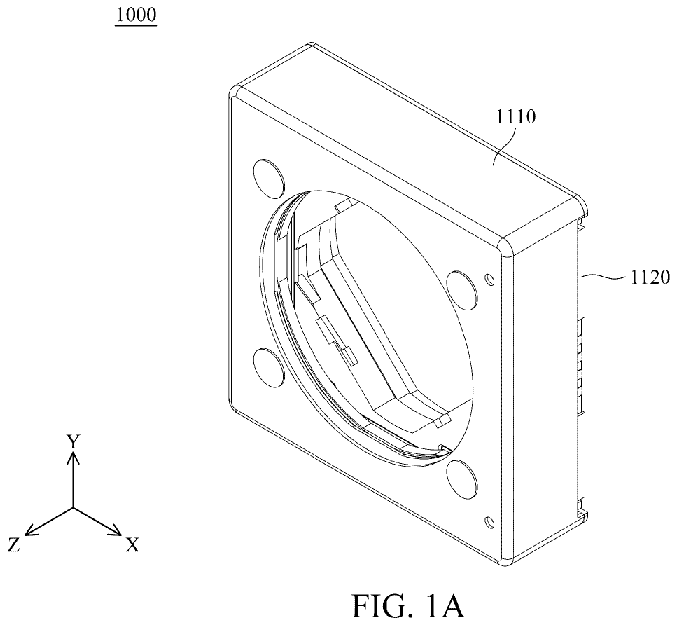

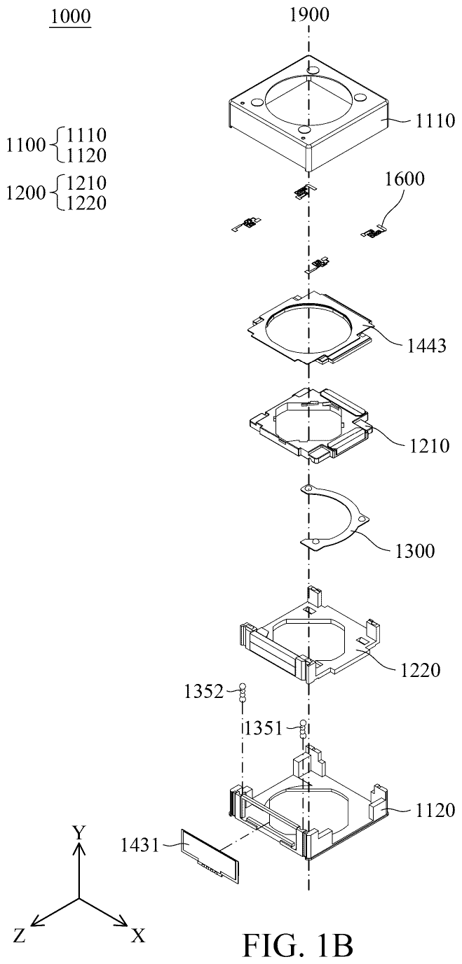

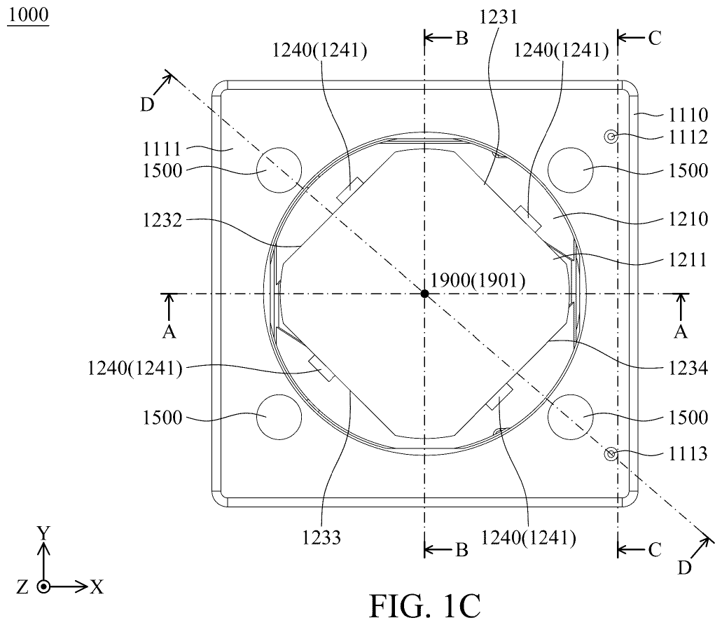

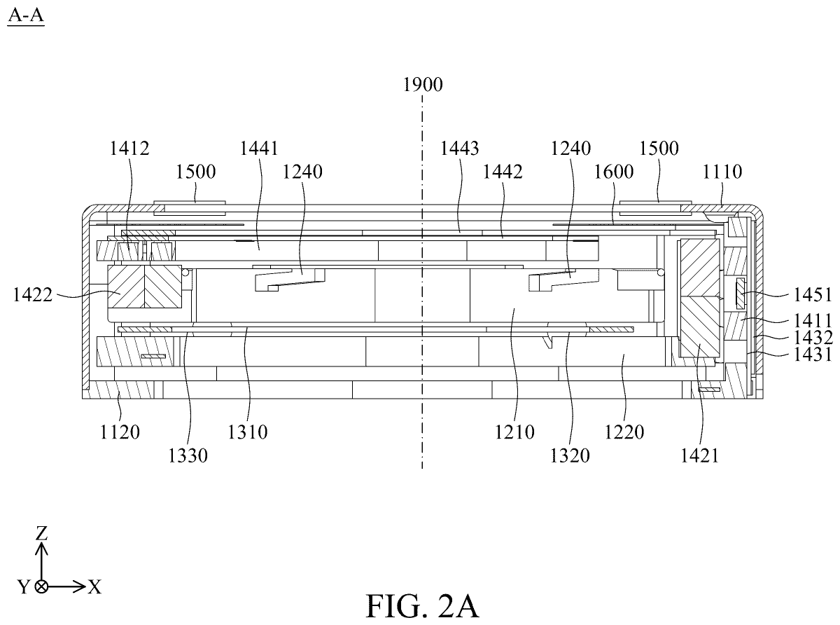

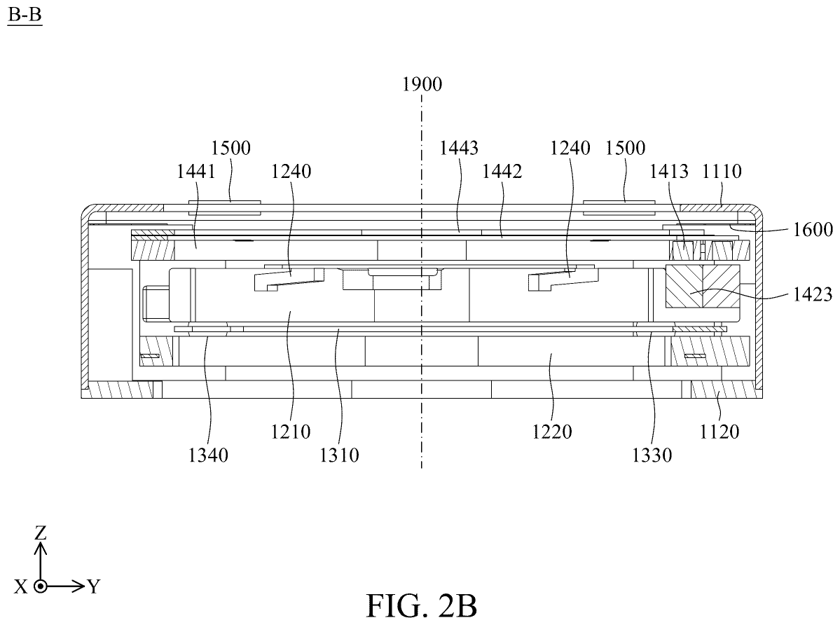

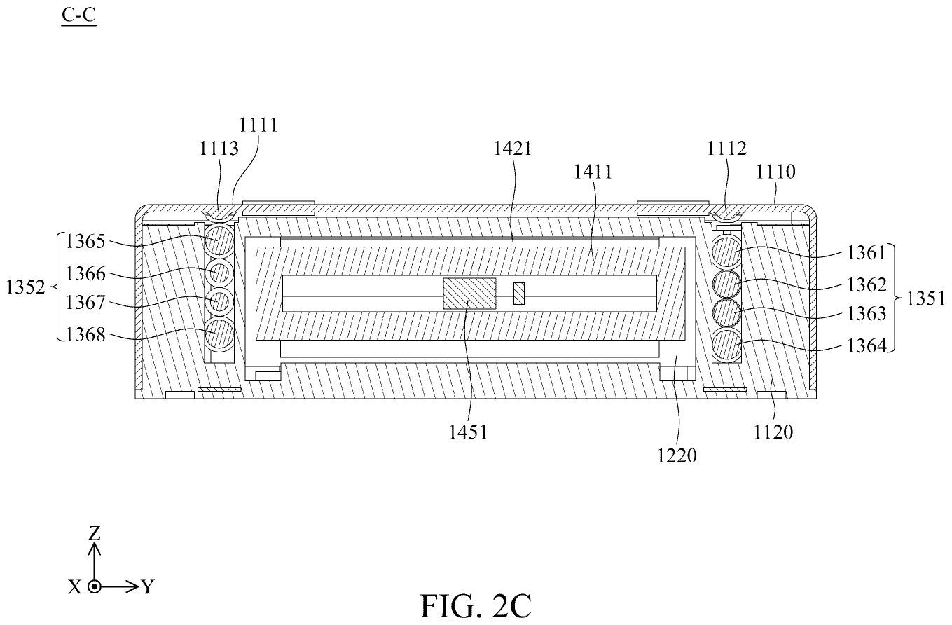

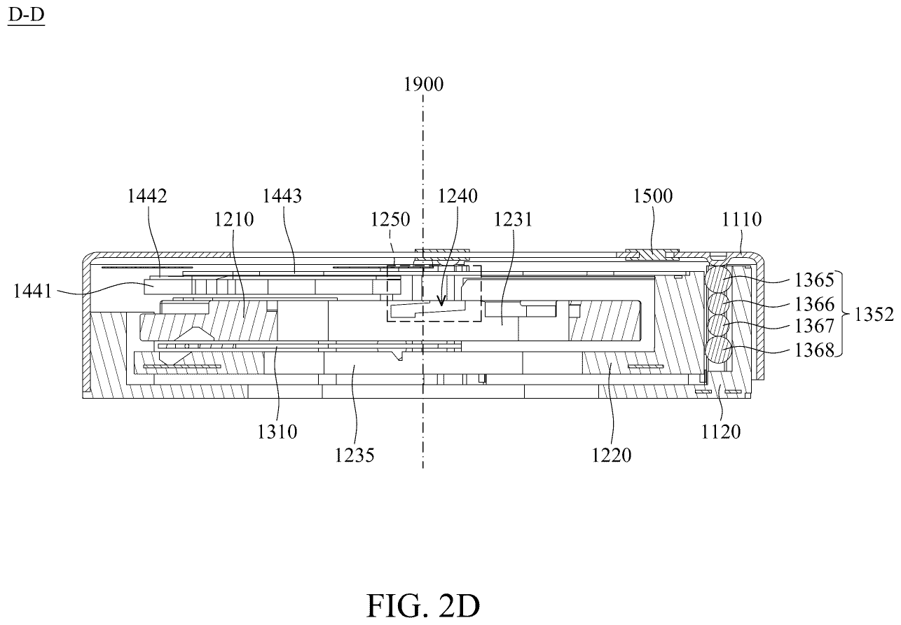

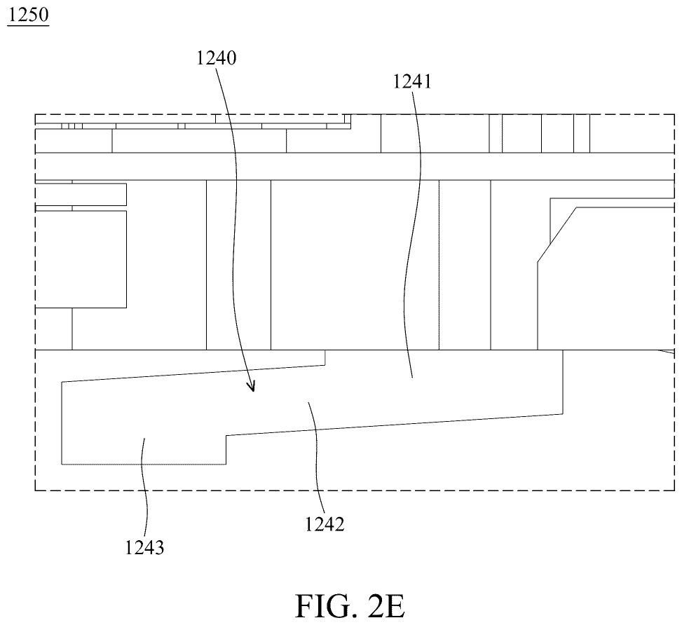

The embodiments of the present disclosure provide an optical element driving mechanism for driving a movable portion to move relative to a fixed portion. For example, FIG. 1A is a schematic view of the optical element driving mechanism 1000. FIG. 1B is an exploded view of the optical element driving mechanism 1000. FIG. 1C is a top view of the optical element driving mechanism 1000. FIG. 2A is a cross-sectional view taken along line A-A of FIG. 1C. FIG. 2B is a cross-sectional view taken along line B-B of FIG. 1C. FIG. 2C is a cross-sectional view taken along line C-C of FIG. 1C. FIG. 2D is a cross-sectional view taken along line D-D of FIG. 1C.

As shown in FIGS. 1A to 2D, in some embodiments, the optical element driving mechanism 1000 may mainly include a fixed portion 1100, a movable assembly 1200, a connecting assembly 1300, a first connecting portion 1351, a second connecting portion 1352, a driving assembly 1400, a first circuit element 1431, a first reinforcing element 1432, a driving element 1441, a second circuit element 1442, a second reinforcing element 1443, a buffering element 1500, and an elastic element 1600, all arranged along a main axis 1900, wherein the main axis 1900 may extend in the Z direction.

In some embodiments, the fixed portion 1100 may include a case 1110 and a bottom 1120. The case 1110 and the bottom 1120 may be arranged along the main axis 1900 and may be combined with each other to form a casing of the optical element driving mechanism 1000 for accommodating other elements. For example, the bottom 1120 may be fixedly connected to the case 1110. It should be understood that openings are respectively formed on the case 1110 and the bottom 1120, the centers of the openings correspond to the main axis 1900 and to an image sensor disposed outside the optical element driving mechanism 1000 (not shown in the drawings). Accordingly, an optical element disposed in the optical element driving mechanism 1000 may be focused with the image sensing element in the direction extending along the main axis 1900.

In some embodiments, the movable assembly 1200 may be disposed in the fixed portion 1100 and may include a first movable portion 1210 and a second movable portion 1220. The movable assembly 1200 may be used to dispose an optical element (not shown). The optical element may be, for example, a lens, a mirror, a prism, a reflective polished surface, an optical coating, a beam splitter, an aperture, a liquid lens, an image sensor, a camera module, a ranging module, and the like. It should be noted that the definition of the optical element here is not limited to elements related to visible light, but may also include elements related to invisible light (such as infrared light and ultraviolet light).

Specifically, the first movable portion 1210 may have a first opening 1211, and the optical element may be disposed in the first opening 1211. The first movable portion 1210 may be disposed on the second movable portion 1220 and may move relative to the second movable portion 1220, for example, moving in the XY plane to achieve optical image stabilization (OIS). The second movable portion 1220 may be disposed on the fixed portion 1100 (for example, the bottom 1120) and may move relative to the fixed portion 1100, for example, moving along the Z axis to achieve auto focus (AF). By using the first movable portion 1210 and the second movable portion 1220, which can move relative to each other, the movement of the optical element in different dimensions may be controlled more precisely, thereby obtaining better imaging results.

The connecting assembly 1300 may be disposed between the first movable portion 1210 and the second movable portion 1220, for example, at least partially overlapping on the Z axis, to reduce the friction when the first movable portion 1210 and the second movable portion 1220 move, and to control the moving direction of the first movable portion 1210 relative to the second movable portion 1220. The driving assembly 1400 may be disposed between the fixed portion 1100 and the movable assembly 1200 to drive the movable assembly 1200 to move relative to the fixed portion 1100 in various directions, so that auto focus (AF) or optical image stabilization (OIS) may be performed.

In some embodiments, the first connecting portion 1351 and the second connecting portion 1352 may be disposed on the fixed portion 1100, for example, between the bottom 1120 and the second movable portion 1220, for controlling the movement direction of the second movable portion 1220 relative to the bottom 1120. The first circuit element 1431 and the second circuit element 1442 may be disposed on the fixed portion 1100 for electrically connecting the driving assembly 1400 to provide the energy and control signals required for the operation of the driving assembly 1400. The first reinforcing element 1432 and the second reinforcing element 1443 may be respectively disposed on the first circuit element 1431 and the second circuit element 1442 to enhance the rigidity of the first circuit element 1431 and the second circuit element 1442. The driving assembly 1400 may be partially disposed in the driving element 1441 to protect the driving assembly 1400. The buffering element 1500 may be disposed on the case 1110 and may be exposed outside the case 1110, having a flexible material, so as to protect the optical element driving mechanism 1000 from excessive impact when the optical element driving mechanism 1000 contacts other external elements. The elastic element 1600 may be disposed on the fixed portion 1100 or the movable assembly 1200 for electrically connecting the driving assembly 1400 to transmit an electric signal controlling the driving assembly 1400 to the driving assembly 1400. For example, one end of the elastic element 1600 may be disposed at a corner of the bottom 1120, and the other end may be physically and electrically connected to the second circuit element 1442.

FIG. 2E is an enlarged view of a region 1250 in FIG. 2D. As shown in FIGS. 1C, 2A, 2B, 2D, and 2E, the first movable portion 1210 may have a plurality of recesses 1240 located at a first opening side 1231, a second opening side 1232, a third opening side 1233, and a fourth opening side 1234. Each recess 1240 may include a first portion 1241, a second portion 1242, and a third portion 1243. The second portion 1242 is located between the first portion 1241 and the third portion 1243 and connects the first portion 1241 and the third portion 1243. The first portion 1241 and the third portion 1243 may extend in the same direction, for example, extending along a direction parallel to the main axis 1900 (parallel to the Z axis). In addition, extending directions of the first portion 1241 and the third portion 1243 are different from the extending direction of the second portion 1242, for example, the extending direction of the second portion 1242 may be not parallel to the main axis 1900. In some embodiments, as shown in FIG. 2E, in the direction extending along the main axis 1900, the first portion 1241 and the third portion 1243 do not overlap each other. In some embodiments, as shown in FIG. 1C, when viewed along a direction parallel to the main axis 1900, the first portion 1241 is exposed from the first movable portion 1210, while the second portion 1242 and the third portion 1243 are not exposed from the first movable portion 1210 in this direction. In addition, as shown in FIGS. 2A, 2B, 2D, and 2E, when viewed along a direction perpendicular to the main axis 1900, the first portion 1241, the second portion 1242, and the third portion 1243 are exposed from the first movable portion 1210. By providing the recesses 1240, additional bonding elements (not shown) may be filled in the recesses 1240 to fix the relative position of the first movable portion 1210 and the optical element (not shown).

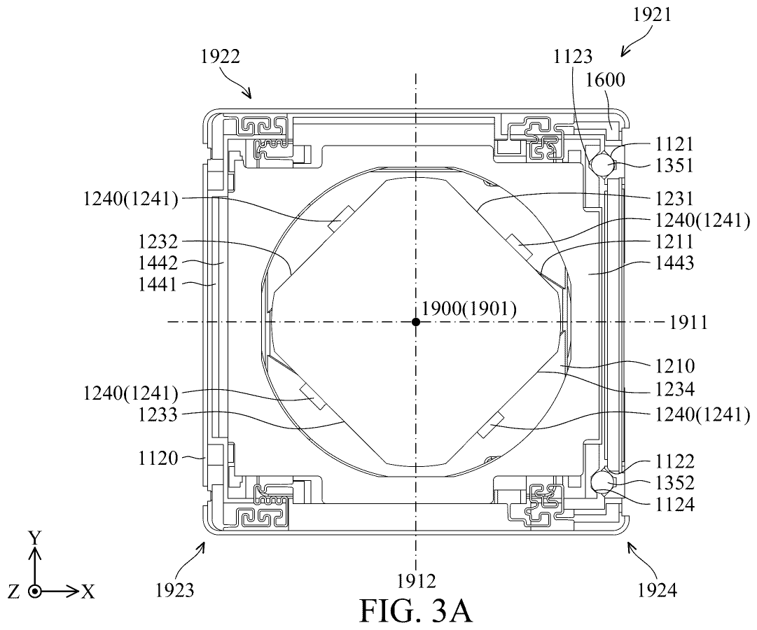

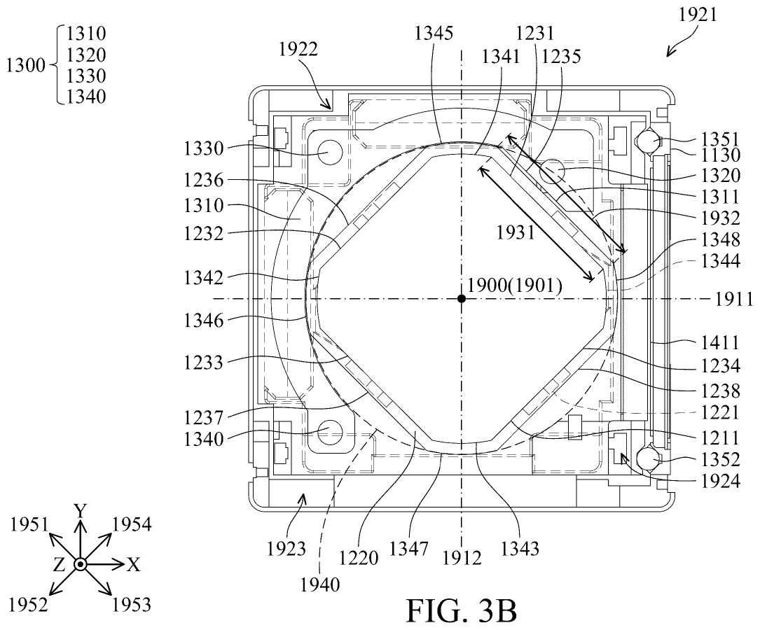

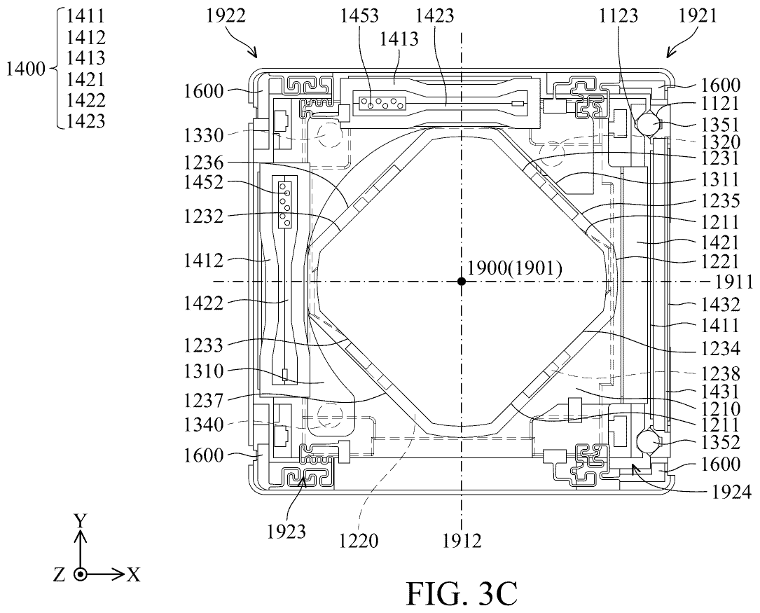

FIGS. 3A, 3B, and 3C are top views of some elements of the optical element driving mechanism 1000, wherein different elements are omitted to better show the relative relationship of other elements. As shown in FIGS. 3A to 3C, the main axis 1900 may pass through a center 1901 of the optical element driving mechanism 1000, which may be a geometric center or a mass center. In the top view, a first reference axis 1911 and a second reference axis 1912 may pass through and intersect at the center 1901. The first reference axis 1911 extends along a first axis (for example, the X axis), and the second reference axis 1912 extends along a second axis (for example, the Y axis), and the first reference axis 1911 and the second reference axis 1912 are perpendicular to each other. The first reference axis 1911 and the second reference axis 1912 divide the top view into four quadrants, which in a counterclockwise order are a first quadrant 1921, a second quadrant 1922, a third quadrant 1923, and a fourth quadrant 1924.

The first opening 1211 may have the first opening side 1231, the second opening side 1232, the third opening side 1233, the fourth opening side 1234, a first connecting side 1341, a second connecting side 1342, a third connecting side 1343, and a fourth connecting side 1344. The first opening side 1231, the second opening side 1232, the third opening side 1233, and the fourth opening side 1234 may have a linear shape, while the first connecting side 1341, the second connecting side 1342, the third connecting side 1343, and the fourth connecting side 1344 may have an arcuate shape. The first connecting side 1341 connects the first opening side 1231 and the second opening side 1232, the second connecting side 1342 connects the second opening side 1232 and the third opening side 1233, the third connecting side 1343 connects the third opening side 1233 and the fourth opening side 1234, and the fourth connecting side 1344 connects the fourth opening side 1234 and the first opening side 1231. In some embodiments, the first opening side 1231 is located in the first quadrant 1921, the second opening side 1232 is located in the second quadrant 1922, the third opening side 1233 is located in the third quadrant 1923, and the fourth opening side 1234 is located in the fourth quadrant 1924.

In some embodiments, as shown in FIG. 3B, the first reference axis 1911 passes through the second connecting side 1342 and the fourth connecting side 1344, the second reference axis 1912 passes through the first connecting side 1341 and the third connecting side 1343, and the first reference axis 1911 and the second reference axis 1912 do not pass through the first opening side 1231, the second opening side 1232, the third opening side 1233, or the fourth opening side 1234. In some embodiments, the first opening side 1231 may extend toward a first direction 1951, the second opening side 1232 may extend toward a second direction 1952, the third opening side 1233 may extend toward a third direction 1953, and the fourth opening side 1234 may extend toward a fourth direction 1954. The first direction 1951 and the third direction 1953 may be parallel to each other (for example, opposite to each other), and the second direction 1952 and the fourth direction 1954 may be parallel to each other (for example, opposite to each other). The first direction 1951 and the third direction 1953 may be different from the second direction 1952 and the fourth direction 1954, for example, the first direction 1951 or the third direction 1953 may be perpendicular to the second direction 1952 or the fourth direction 1954. In some embodiments, the first direction 1951 may be a direction at a 45 degree angle between the −X direction and the +Y direction, the second direction 1952 may be a direction at a 45 degree angle between the −X direction and the −Y direction, the third direction 1953 may be a direction at a 45 degree angle between the +X direction and the −Y direction, and the fourth direction 1954 may be a direction at a 45 degree angle between the +X direction and the +Y direction.

In addition, the second movable portion 1220 may have a second opening 1221. When viewed along the main axis 1900, the first opening 1211 is surrounded by the second opening 1221. In some embodiments, the second opening 1221 includes a fifth opening side 1235, a sixth opening side 1236, a seventh opening side 1237, an eighth opening side 1238, a fifth connecting side 1345, a sixth connecting side 1346, a seventh connecting side 1347, and an eighth connecting side 1348. The fifth opening side 1235, the sixth opening side 1236, the seventh opening side 1237, and the eighth opening side 1238 may have a linear shape, while the fifth connecting side 1345, the sixth connecting side 1346, the seventh connecting side 1347, and the eighth connecting side 1348 may have an arcuate shape. The fifth connecting side 1345 connects the fifth opening side 1235 and the sixth opening side 1236, the sixth connecting side 1346 connects the sixth opening side 1236 and the seventh opening side 1237, the seventh connecting side 1347 connects the seventh opening side 1237 and the eighth opening side 1238, and the eighth connecting side 1348 connects the eighth opening side 1238 and the fifth opening side 1235. In some embodiments, the fifth opening side 1235 is located in the first quadrant 1921, the sixth opening side 1236 is located in the second quadrant 1922, the seventh opening side 1237 is located in the third quadrant 1923, and the eighth opening side 1238 is located in the fourth quadrant 1924.

In some embodiments, as shown in FIG. 3B, the first reference axis 1911 passes through the sixth connecting side 1346 and the eighth connecting side 1348, the second reference axis 1912 passes through the fifth connecting side 1345 and the seventh connecting side 1347, and the first reference axis 1911 and the second reference axis 1912 do not pass through the fifth opening side 1235, the sixth opening side 1236, the seventh opening side 1237, or the eighth opening side 1238. In some embodiments, the fifth opening side 1235 may extend toward the first direction 1951, the sixth opening side 1236 may extend toward the second direction 1952, the seventh opening side 1237 may extend toward the third direction 1953, and the eighth opening side 1238 may extend toward the fourth direction 1954.

In some embodiments, when viewed along the main axis 1900, since the first opening 1211 is surrounded by the second opening 1221, the first opening 1211 is smaller than the second opening 1221. Specifically, the minimum distance between the first opening side 1231 and the center 1901 is different from the minimum distance between the fifth opening side 1235 and the center 1901. For example, the minimum distance between the first opening side 1231 and the center 1901 is smaller than the minimum distance between the fifth opening side 1235 and the center 1901 (for example, the distance in the second direction 1952). Similarly, the minimum distance between the second opening side 1232 and the center 1901 is different from the minimum distance between the sixth opening side 1236 and the center 1901, the minimum distance between the third opening side 1233 and the center 1901 is different from the minimum distance between the seventh opening side 1237 and the center 1901, and the minimum distance between the fourth opening side 1234 and the center 1901 is different from the minimum distance between the eighth opening side 1238 and the center 1901. For example, the minimum distance between the second opening side 1232 and the center 1901 is smaller than the minimum distance between the sixth opening side 1236 and the center 1901, the minimum distance between the third opening side 1233 and the center 1901 is smaller than the minimum distance between the seventh opening side 1237 and the center 1901, and the minimum distance between the fourth opening side 1234 and the center 1901 is smaller than the minimum distance between the eighth opening side 1238 and the center 1901. In addition, when viewed along the main axis 1900, the first opening side 1231 may have a first length 1931, the fifth opening side 1235 may have a second length 1932, and the first length 1931 and the second length 1932 may be different from each other. For example, the first length 1931 may be smaller than the second length 1932.

In some embodiments, a reference circle 1940 may be defined, with the center 1901 as the circle center, and with the minimum distance between the center 1901 and the first connecting side 1341 in the direction extending along the first reference axis 1911 as the radius. In some embodiments, the first connecting side 1341, the second connecting side 1342, the third connecting side 1343, and the fourth connecting side 1344 having arcuate shapes are arcs with the center 1901 as the curvature center. Therefore, the first connecting side 1341, the second connecting side 1342, the third connecting side 1343, and the fourth connecting side 1344 are substantially tangent to the reference circle 1940.

In some embodiments, as shown in FIGS. 2A, 2B, and 3B, the connecting assembly 1300 may include a first connecting element 1310, a second connecting element 1320, a third connecting element 1330, and a fourth connecting element 1340. The first connecting element 1310 may have a plate-shaped structure and may be used to connect with the second connecting element 1320, the third connecting element 1330, and the fourth connecting element 1340, while the second connecting element 1320, the third connecting element 1330, and the fourth connecting element 1340 are movably connected between the first movable portion 1210 and the second movable portion 1220. For example, the second connecting element 1320, the third connecting element 1330, and the fourth connecting element 1340 have a spherical shape and may be movably and partially disposed in corresponding recesses of the first movable portion 1210 and the second movable portion 1220 to directly contact the first movable portion 1210 and the second movable portion 1220, thereby reducing friction when the second movable portion 1220 moves relative to the first movable portion 1210.

In some embodiments, by designing the first opening 1211 and the second opening 1221 with straight-sided shapes and smaller than the reference circle 1940, the space between the reference circle 1940 and the first opening 1211 (or the second opening 1221) may be used to dispose other elements (for example, the connecting assembly 1300). For example, a portion of the connecting assembly 1300 may be at least partially located in the reference circle 1940. As shown in FIG. 3B, the first connecting element 1310 may have a connecting element side 1311 with a linear shape and parallel to the first opening side 1231. When viewed along the main axis 1900, the connecting element side 1311 may be at least partially located in the reference circle 1940, while the fifth opening side 1235 is located between the first opening side 1231 and the connecting element side 1311, and the reference circle 1940 at least partially overlaps with the connecting assembly 1300. Accordingly, the overall size of the connecting assembly 1300 may be reduced inward (toward the center 1901) to achieve miniaturization.

In some embodiments, in the first quadrant 1921, the first connecting element 1310 is at least partially located between the reference circle 1940 and the first opening 1211, and is also at least partially located between the reference circle 1940 and the second opening 1221. In addition, in the first quadrant 1921, the second connecting element 1320 is at least partially located between the reference circle 1940 and the first opening 1211, and is also at least partially located between the reference circle 1940 and the second opening 1221. In the second quadrant 1922, the third quadrant 1923, and the fourth quadrant 1924, the connecting assembly 1300 is not located between the reference circle 1940 and the second opening 1221. For example, when viewed along the main axis 1900, the reference circle 1940 may pass through between the third connecting element 1330 and the sixth opening side 1236, and may also pass through between the fourth connecting element 1340 and the seventh opening side 1237.

In some embodiments, as shown in FIGS. 2A, 2B, and 3C, the driving assembly 1400 may include a first coil 1411, a second coil 1412, a third coil 1413, a first magnetic element 1421, a second magnetic element 1422, and a third magnetic element 1423, which may be disposed between the fixed portion 1100 and the first movable portion 1210. For example, they may be disposed between the case 1110 and the first movable portion 1210, or between the bottom 1120 and the first movable portion 1210. The first magnetic element 1421 may correspond to the first coil 1411, the second magnetic element 1422 may correspond to the second coil 1412, and the third magnetic element 1423 may correspond to the third coil 1413. For example, the first magnetic element 1421, the second magnetic element 1422, and the third magnetic element 1423 may be magnets. When the first coil 1411, the second coil 1412, and the third coil 1413 are energized, they may respectively interact with the magnetic fields of the first magnetic element 1421, the second magnetic element 1422, and the third magnetic element 1423 to generate electromagnetic driving force, thereby driving the first movable portion 1210 or the second movable portion 1220 to move relative to the fixed portion 1100.

In some embodiments, the first coil 1411, the first circuit element 1431, and the first reinforcing element 1432 may be fixedly disposed on the same side of the bottom 1120, and the first circuit element 1431 may be disposed between the first coil 1411 and the first reinforcing element 1432. The first circuit element 1431 may be electrically connected to the first coil 1411 and an external circuit of the optical element driving mechanism 1000 to provide the energy and control signals required for the operation of the first coil 1411. In some embodiments, the first circuit element 1431 may include, for example, a printed circuit board (PCB). The first circuit element 1431 may have a flexible material (such as a polymer), and the first reinforcing element 1432 may include, for example, a magnetically conductive metal material and may have a plate-shaped structure. When the first reinforcing element 1432 is attached to the first circuit element 1431, it may provide overall structural strength and may also have a magnetically conductive function to further concentrate the magnetic flux lines of the first coil 1411 to obtain a stronger electromagnetic driving force.

The first magnetic element 1421 may be fixedly disposed on the second movable portion 1220 so that it may move relative to the first coil 1411. In some embodiments, along the X axis, the first coil 1411 and the first magnetic element 1421 are at least partially overlapped with each other. In some embodiments, the positions of the first coil 1411 and the first magnetic element 1421 may be interchanged, for example, the first coil 1411 may be fixedly disposed on the second movable portion 1220, and the first magnetic element 1421 may be disposed on the bottom 1120, depending on design requirements. The first coil 1411 and the first magnetic element 1421 may generate electromagnetic driving force in the Z axis direction to drive the second movable portion 1220 to move relative to the fixed portion 1100 in the Z axis direction to achieve the auto focus.

In some embodiments, as shown in FIGS. 2A and 2B, the second coil 1412 and the third coil 1413 may be disposed in the driving element 1441. The driving element 1441 may, for example, have a plate-shaped structure, and may include additional circuits and a dielectric material covering the circuits and the second coil 1412 and the third coil 1413. The driving element 1441 may be disposed on the same side of the first movable portion 1210 together with the second circuit element 1442 and the second reinforcing element 1443, and the second circuit element 1442 may be disposed between the driving element 1441 and the second reinforcing element 1443. The driving element 1441 may be used to protect the second coil 1412 and the third coil 1413 disposed therein. The second circuit element 1442 may be electrically connected to the driving element 1441, for example, electrically connected to the second coil 1412 and the third coil 1413, to provide the energy and control signals required for the operation of the second coil 1412 and the third coil 1413. In some embodiments, the second circuit element 1442 may include, for example, a printed circuit board. The second circuit element 1442 may have a flexible material (such as a polymer), and the second reinforcing element 1443 may include, for example, a magnetically conductive metal material, and may have a plate-shaped structure. When the second reinforcing element 1443 is attached to the second circuit element 1442, it may provide overall structural strength and may also have a magnetically conductive function to further concentrate the magnetic flux lines of the second coil 1412 and the third coil 1413 to obtain a stronger electromagnetic driving force.

The second coil 1412 and the third coil 1413 may be fixedly disposed on the second movable portion 1220, and the second magnetic element 1422 and the third magnetic element 1423 may be fixedly disposed on the first movable portion 1210, so that the second magnetic element 1422 and the third magnetic element 1423 may move relative to the second coil 1412 and the third coil 1413. In some embodiments, along the Z axis, the second coil 1412 and the third coil 1413 are respectively at least partially overlapped with the second magnetic element 1422 and the third magnetic element 1423. In some embodiments, the positions of the second coil 1412 and the third coil 1413 may be respectively interchanged with the second magnetic element 1422 and the third magnetic element 1423, depending on design requirements. The second coil 1412 and the third coil 1413 may respectively generate electromagnetic driving force with the second magnetic element 1422 and the third magnetic element 1423 in the XY plane to drive the first movable portion 1210 to move relative to the second movable portion 1220 in the XY plane, so as to achieve optical image stabilization. In some embodiments, the first coil 1411 may be located on a different side of the first movable portion 1210 from the second coil 1412 and the third coil 1413, while the second coil 1412 and the third coil 1413 are located on the same side of the first movable portion 1210.

Although the driving assembly 1400 includes a combination of magnetic elements and coils in the previous embodiments, the present disclosure is not limited thereto. In some embodiments, the driving assembly 1400 may also include driving elements such as piezoelectric elements or shape memory alloys (SMA).

In some embodiments, as shown in FIGS. 2A, 2C, and 3C, the optical element driving mechanism 1000 may further include a first sensing element 1451, a second sensing element 1452, and a third sensing element 1453. The first sensing element 1451 may be disposed on the first circuit element 1431 and electrically connected to the first circuit element 1431, and surrounded by the first coil 1411. Along the X axis, the first sensing element 1451 and the first magnetic element 1421 are at least partially overlapped with each other, so that when the second movable portion 1220 moves relative to the bottom 1120 (which means when the first magnetic element 1421 moves relative to the first sensing element 1451), the magnetic field change of the first magnetic element 1421 may be detected, thereby obtaining the position of the second movable portion 1220 relative to the bottom 1120, so as to further control the second movable portion 1220.

Similarly, the second sensing element 1452 and the third sensing element 1453 may be disposed on the second circuit element 1442 and electrically connected to the second circuit element 1442, and respectively surrounded by the second coil 1412 and the third coil 1413. Along the Z axis, the second sensing element 1452 and the third sensing element 1453 are respectively at least partially overlapped with the second magnetic element 1422 and the third magnetic element 1423, so that when the first movable portion 1210 moves relative to the second movable portion 1220 (which means when the second magnetic element 1422 and the third magnetic element 1423 respectively move relative to the second sensing element 1452 and the third sensing element 1453), the magnetic field changes of the second magnetic element 1422 and the third magnetic element 1423 may be detected, thereby obtaining the position of the first movable portion 1210 relative to the second movable portion 1220, so as to further control the first movable portion 1210.

In some embodiments, the aforementioned first sensing element 1451, second sensing element 1452, and third sensing element 1453 may include a Hall sensor, a magnetoresistance effect sensor (MR sensor), a giant magnetoresistance effect sensor (GMR sensor), a tunneling magnetoresistance effect sensor (TMR sensor), or a fluxgate sensor.

In addition, a first connecting portion 1351 and a second connecting portion 1352 may be disposed between the bottom 1120 and the second movable portion 1220 to control the movement direction of the second movable portion 1220 relative to the bottom 1120. In some embodiments, as shown in FIG. 3B, the bottom 1120 includes a side 1130, the first connecting portion 1351 and the second connecting portion 1352 are arranged along a direction parallel to the side 1130 (parallel to the Y axis), and the second reference axis 1912 may be parallel to the side 1130.

In some embodiments, as shown in FIG. 2C, the first connecting portion 1351 may include a first connecting unit 1361, a second connecting unit 1362, a third connecting unit 1363, and a fourth connecting unit 1364, extending along the main axis 1900, such as sequentially arranged along the Z axis. In addition, the second connecting portion 1352 may include a fifth connecting unit 1365, a sixth connecting unit 1366, a seventh connecting unit 1367, and an eighth connecting unit 1368, extending along the main axis 1900, such as sequentially arranged along the Z axis. The first connecting unit 1361, the second connecting unit 1362, the third connecting unit 1363, the fourth connecting unit 1364, the fifth connecting unit 1365, the sixth connecting unit 1366, the seventh connecting unit 1367, and the eighth connecting unit 1368 may have a spherical shape.

In addition, as shown in FIG. 3A, the bottom 1120 may have a first recess 1121 and a second recess 1122, and the second movable portion 1220 may have a third recess 1123 and a fourth recess 1124. The first connecting portion 1351 may be disposed in the first recess 1121 and the third recess 1123, and the second connecting portion 1352 may be disposed in the second recess 1122 and the fourth recess 1124. The first recess 1121, the second recess 1122, the third recess 1123, and the fourth recess 1124 may extend along the Z axis. In some embodiments, the first connecting unit 1361, the second connecting unit 1362, the third connecting unit 1363, and the fourth connecting unit 1364 may roll in the first recess 1121 and the third recess 1123, and the fifth connecting unit 1365, the sixth connecting unit 1366, the seventh connecting unit 1367, and the eighth connecting unit 1368 may roll in the second recess 1122 and the fourth recess 1124 to reduce friction when the second movable portion 1220 moves relative to the bottom 1120, and also to control the movement direction of the second movable portion 1220 relative to the bottom 1120 in a direction parallel to the main axis 1900 (parallel to the Z axis).

In some embodiments, the size (for example, diameter) of the first connecting unit 1361 and the fourth connecting unit 1364 may be larger than the size of the second connecting unit 1362 and the third connecting unit 1363, and the size of the fifth connecting unit 1365 and the eighth connecting unit 1368 may be larger than the size of the sixth connecting unit 1366 and the seventh connecting unit 1367. By disposing the two smaller connecting units between the larger connecting units, rolling may be promoted to reduce mutual sliding phenomena between the connecting units and to improve the smoothness of movement.

In some embodiments, as shown in FIGS. 1C and 2C, case recesses 1112 and 1113 recessed from the upper surface 1111 may be designed on the case 1110, wherein the case recess 1112 overlaps with the first connecting portion 1351 in the Z axis direction, and the case recess 1113 overlaps with the second connecting portion 1352 in the Z axis direction. The case recesses 1112 and 1113 are arranged along the Y axis. The case recesses 1112 and 1113 may be used to position the orientation of the case 1110, so as to ensure the correct assembly direction of the case 1110 when the case 1110 is assembled onto the bottom 1120.

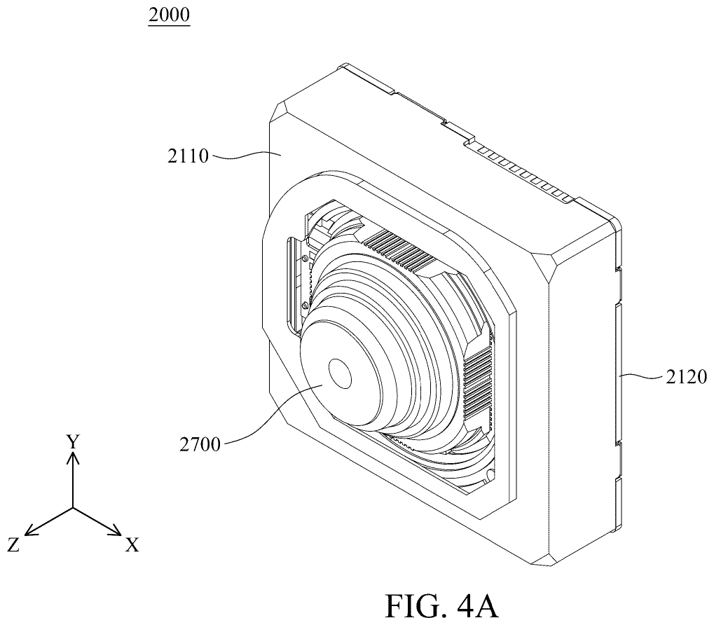

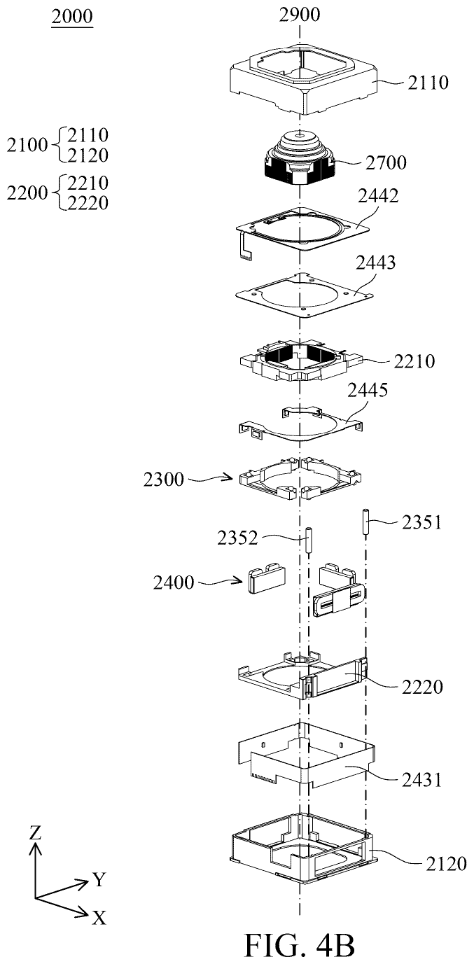

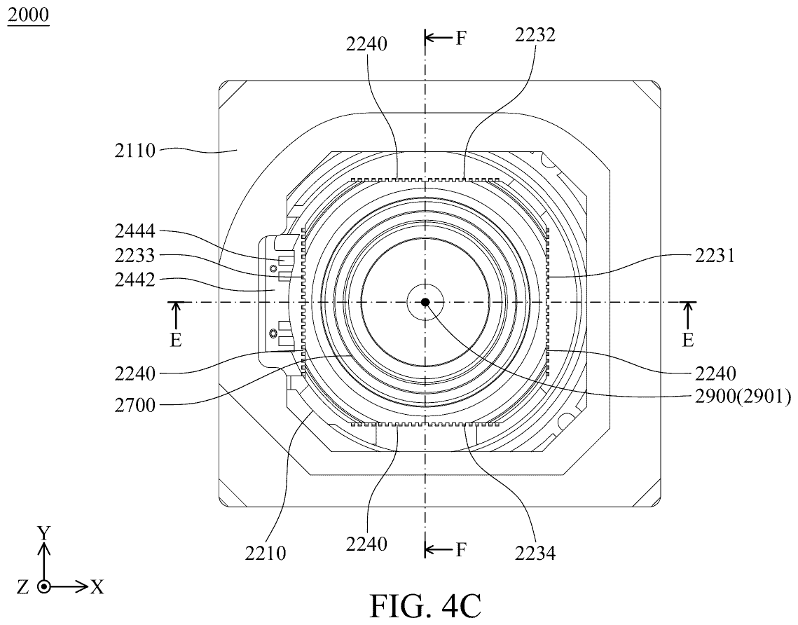

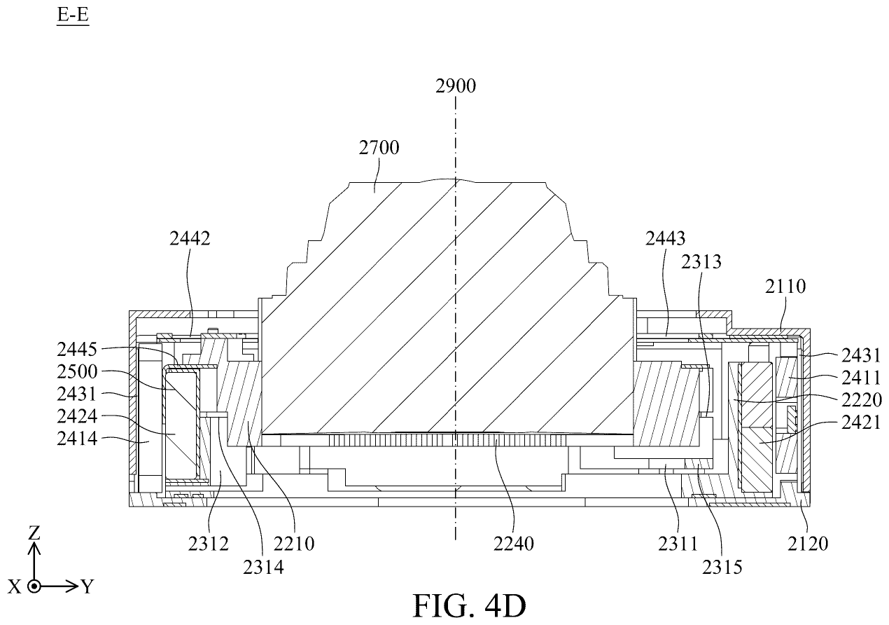

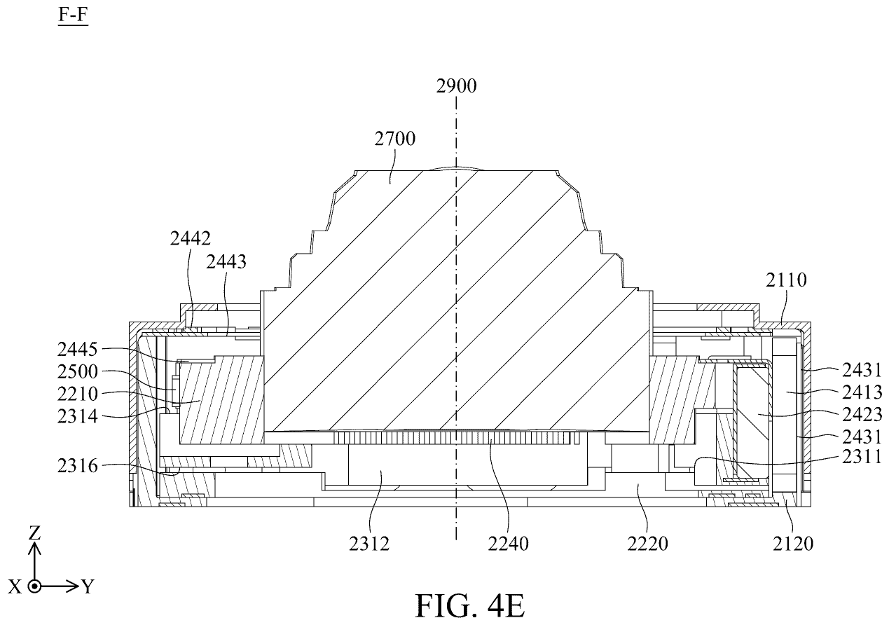

The aforementioned embodiments disclose an optical element driving mechanism 1000 having straight-shaped opening sides, but the present disclosure is not limited thereto. For example, FIG. 4A is a schematic view of an optical element driving mechanism 2000 according to other embodiments of the present disclosure. FIG. 4B is an exploded view of the optical element driving mechanism 2000. FIG. 4C is a top view of the optical element driving mechanism 2000. FIG. 4D is a cross-sectional view taken along line E-E of FIG. 4C. FIG. 4E is a cross-sectional view taken along line F-F of FIG. 4C. As shown in FIGS. 4A to 4E, the optical element driving mechanism 2000 may mainly include a fixed portion 2100 (including a case 2110 and a bottom 2120), a movable assembly 2200 (including a first movable portion 2210 and a second movable portion 2220), a connecting assembly 2300, a first connecting portion 2351, a second connecting portion 2352, a driving assembly 2400, a first circuit element 2431, a second circuit element 2442, a second reinforcing element 2443, and a third reinforcing element 2445, all arranged along a main axis 2900, for driving an optical element 2700 to move.

The optical element 2700 may be, for example, a lens, a mirror, a prism, a reflective polished surface, an optical coating, a beam splitter, an aperture, a liquid lens, an image sensor, a camera module, a ranging module, and the like. It should be noted that the definition of the optical element here is not limited to elements related to visible light, but may also include elements related to invisible light (such as infrared light and ultraviolet light).

The case 2110 and the bottom 2120 may be combined with each other to form a casing of the optical element driving mechanism 2000. The second movable portion 2220 may be disposed in the bottom 2120, and the first movable portion 2210 may be disposed in the second movable portion 2220. The driving assembly 2400 may be disposed between the fixed portion 2100 and the movable assembly 2200. The first circuit element 2431 may surround the bottom 2120 (FIGS. 4D and 4E), the second reinforcing element 2443 may be disposed on the bottom 2120, and the second circuit element 2442 may be disposed on the second reinforcing element 2443. The third reinforcing element 2445 may be disposed on the first movable portion 2210.

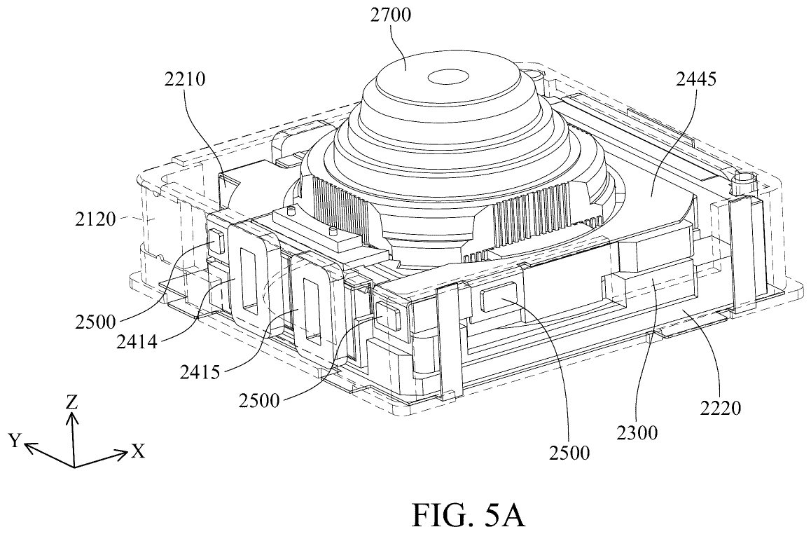

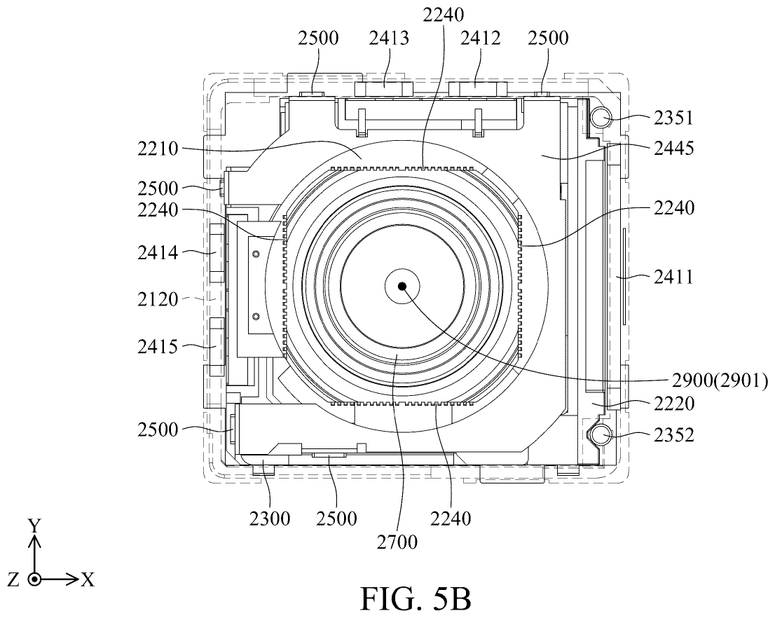

FIG. 5A is a schematic view of some elements of the optical element driving mechanism 2000, and FIG. 5B is a top view of some elements of the optical element driving mechanism 2000. As shown in FIGS. 5A and 5B, the third reinforcing element 2445 may move together with the first movable portion 2210, and a plurality of buffering elements 2500 may be disposed on the third reinforcing element 2445. In some embodiments, the first movable portion 2210 and the buffering elements 2500 may be disposed on opposite sides of the third reinforcing element 2445. For example, as shown in FIG. 5B, the first movable portion 2210 may be disposed on the inner side of the third reinforcing element 2445, and the buffering elements 2500 may be disposed on the outer side of the third reinforcing element 2445, so as to provide a buffering function when the first movable portion 2210 moves.

In some embodiments, the second circuit element 2442 may be used to electrically connect the optical element driving mechanism 2000 with other external devices (not shown). For example, as shown in FIG. 4C, when viewed along the main axis 2900, the electrical contact 2444 of the second circuit element 2442 is exposed from the case 2110 to electrically connect with other devices disposed above the case 2110, such as an aperture or a shutter.

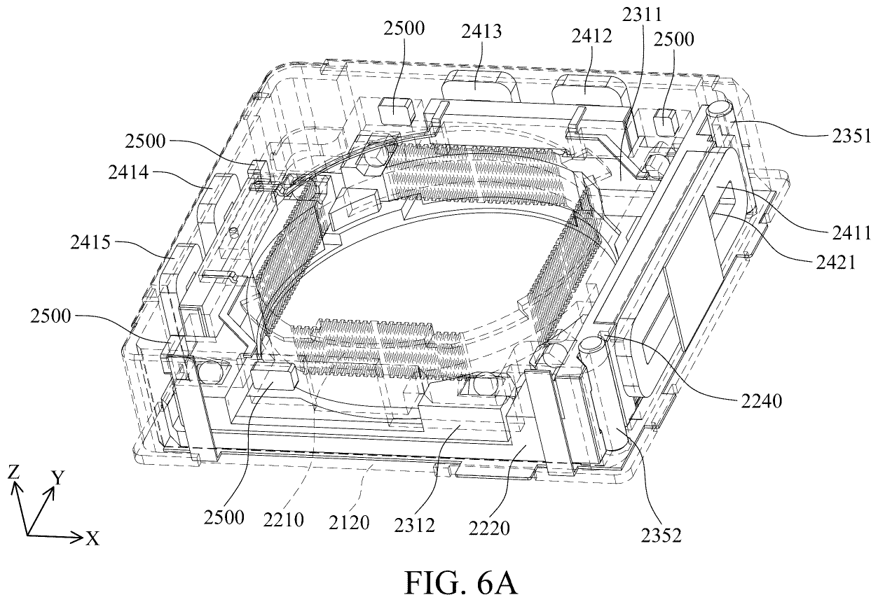

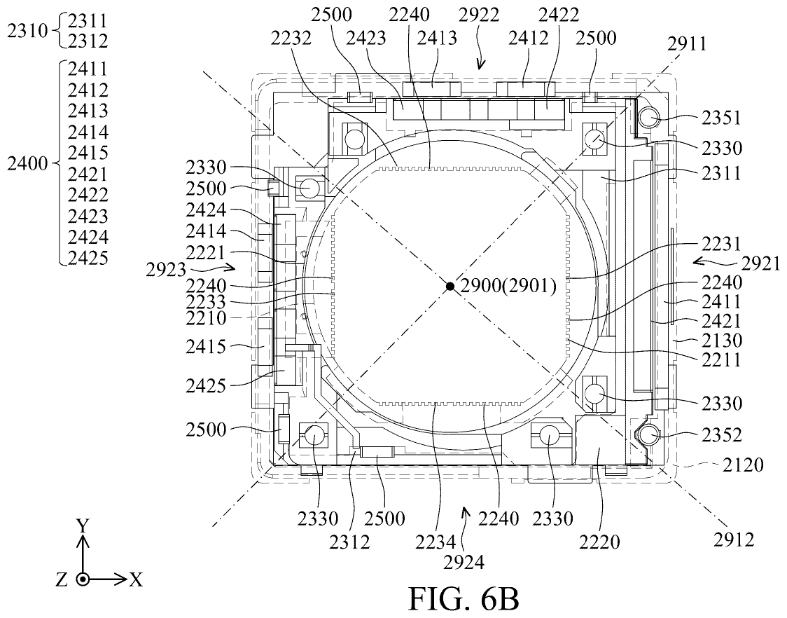

FIG. 6A is a schematic view of some elements of the optical element driving mechanism 2000, and FIG. 6B is a top view of some elements of the optical element driving mechanism 2000. As shown in FIGS. 6A and 6B, the driving assembly 2400 may include a first coil 2411, a second coil 2412, a third coil 2413, a fourth coil 2414, a fifth coil 2415, a first magnetic element 2421, a second magnetic element 2422, a third magnetic element 2423, a fourth magnetic element 2424, and a fifth magnetic element 2425. These elements may be disposed between the fixed portion 2100 and the movable assembly 2200, such as between the bottom 2120 and the first movable portion 2210. In some embodiments, the first coil 2411, the second coil 2412, the third coil 2413, the fourth coil 2414, and the fifth coil 2415 may be disposed on the bottom 2120, the first magnetic element 2421 may be disposed on the second movable portion 2220, and the second magnetic element 2422, the third magnetic element 2423, the fourth magnetic element 2424, and the fifth magnetic element 2425 may be disposed on the first movable portion 2210.

The first coil 2411, the second coil 2412, the third coil 2413, the fourth coil 2414, and the fifth coil 2415 may respectively correspond to the first magnetic element 2421, the second magnetic element 2422, the third magnetic element 2423, the fourth magnetic element 2424, and the fifth magnetic element 2425. For example, the first coil 2411, the fourth coil 2414, and the fifth coil 2415 may respectively at least partially overlap with the first magnetic element 2421, the fourth magnetic element 2424, and the fifth magnetic element 2425 along the X axis, while the second coil 2412 and the third coil 2413 may respectively at least partially overlap with the second magnetic element 2422 and the third magnetic element 2423 along the Y axis. In some embodiments, the positions of the first coil 2411, the second coil 2412, the third coil 2413, the fourth coil 2414, and the fifth coil 2415 may be respectively interchanged with the first magnetic element 2421, the second magnetic element 2422, the third magnetic element 2423, the fourth magnetic element 2424, and the fifth magnetic element 2425, depending on design requirements. As shown in FIGS. 5B and 6B, the first coil 2411 may be disposed on one side of the first movable portion 2210, the second coil 2412 and the third coil 2413 may be disposed on another side of the first movable portion 2210, and the fourth coil 2414 and the fifth coil 2415 may be disposed on yet another side of the first movable portion 2210. In some embodiments, the second coil 2412 and the third coil 2413 may be arranged along the X axis, while the fourth coil 2414 and the fifth coil 2415 may be arranged along the Y axis.

The first coil 2411, the second coil 2412, the third coil 2413, the fourth coil 2414, and the fifth coil 2415 may be disposed on the first circuit element 2431 and electrically connected to the first circuit element 2431, and may respectively interact with the magnetic fields of the first magnetic element 2421, the second magnetic element 2422, the third magnetic element 2423, the fourth magnetic element 2424, and the fifth magnetic element 2425 to generate electromagnetic driving force to drive the first movable portion 2210 or the second movable portion 2220 to move relative to the fixed portion 2100. Specifically, the first coil 2411 and the first magnetic element 2421 may generate a force along the Z axis on the second movable portion 2220 to drive the second movable portion 2220 and the first movable portion 2210 and the optical element 2700 disposed therein to move together along the Z axis to achieve auto focus. In addition, the electromagnetic driving force generated by the second coil 2412, the third coil 2413, the fourth coil 2414, and the fifth coil 2415 together with the second magnetic element 2422, the third magnetic element 2423, the fourth magnetic element 2424, and the fifth magnetic element 2425 may drive the first movable portion 2210 and the optical element 2700 disposed therein to move in the XY plane to achieve the optical image stabilization function.

As shown in FIG. 6B, the first movable portion 2210 may have a first opening 2211. The first opening 2211 may have a first opening side 2231, a second opening side 2232, a third opening side 2233, and a fourth opening side 2234, all having a linear shape. The first opening side 2231 may extend along a first direction (e.g., the X direction), the second opening side 2232 may extend along a second direction (e.g., the Y direction), the third opening side 2233 may extend along a third direction (e.g., the X direction), and the fourth opening side 2234 may extend along a fourth direction (e.g., the Y direction). The first direction (or the third direction) and the second direction (or the fourth direction) may be different, for example, may be perpendicular to each other. The first direction may be parallel to the third direction, and the second direction may be parallel to the fourth direction.

In some embodiments, when viewed along the main axis 2900, the main axis 2900 may pass through a center 2901 of the optical element driving mechanism 2000 (e.g., a geometric center or a mass center). In the top view, a first reference axis 2911 and a second reference axis 2912 may pass through and intersect at the center 2901. The first reference axis 2911 extends along a first axis (e.g., a direction at a 45 degree angle between the +X direction and the +Y direction), and the second reference axis 2912 extends along a second axis (e.g., a direction at a 45 degree angle between the −X direction and the +Y direction), and the first reference axis 2911 and the second reference axis 2912 are perpendicular to each other. The first reference axis 2911 and the second reference axis 2912 divide the top view into four quadrants, which in a counterclockwise order are a first quadrant 2921, a second quadrant 2922, a third quadrant 2923, and a fourth quadrant 2924. When viewed along the main axis 2900, the first opening side 2231, the second opening side 2232, the third opening side 2233, and the fourth opening side 2234 may be respectively located in the first quadrant 2921, the second quadrant 2922, the third quadrant 2923, and the fourth quadrant 2924. The first reference axis 2911 and the second reference axis 2912 do not pass through the first opening side 2231, the second opening side 2232, the third opening side 2233, the fourth opening side 2234, the first coil 2411, the second coil 2412, the third coil 2413, the fourth coil 2414, the fifth coil 2415, the first magnetic element 2421, the second magnetic element 2422, the third magnetic element 2423, the fourth magnetic element 2424, or the fifth magnetic element 2425.

In some embodiments, when viewed along the main axis 2900, in the X axis, the first magnetic element 2421 is located between the first coil 2411 and the first opening side 2231, the fourth magnetic element 2424 is located between the fourth coil 2414 and the third opening side 2233, and the fifth magnetic element 2425 is located between the fifth coil 2415 and the third opening side 2233. In the Y axis, the second magnetic element 2422 is located between the second coil 2412 and the second opening side 2232, and the third magnetic element 2423 is located between the third coil 2413 and the second opening side 2232.

In some embodiments, the first movable portion 2210 may have a plurality of recesses 2240 extending along the main axis 2900 and located on the first opening side 2231, the second opening side 2232, the third opening side 2233, and the fourth opening side 2234. When viewed along the main axis 2900 (FIGS. 4C, 5B, and 6B) and when viewed perpendicular to the main axis 2900 (FIGS. 4D and 4E), the recesses 2240 are exposed from the first movable portion 2210.

In some embodiments, the first connecting portion 2351 and the second connecting portion 2352 may be disposed between the bottom 2120 and the second movable portion 2220, such as fixed on the bottom 2120 and movably connected to the second movable portion 2220. The first connecting portion 2351 and the second connecting portion 2352 may extend along the main axis 2900. In some embodiments, the bottom 2120 has a side 2130, and the first connecting portion 2351 and the second connecting portion 2352 are arranged along a direction parallel to the side 2130 (the Y direction). Accordingly, the movement direction of the second movable portion 2220 relative to the bottom 2120 may be restricted to a direction parallel to the main axis 2900 (parallel to the Z axis).

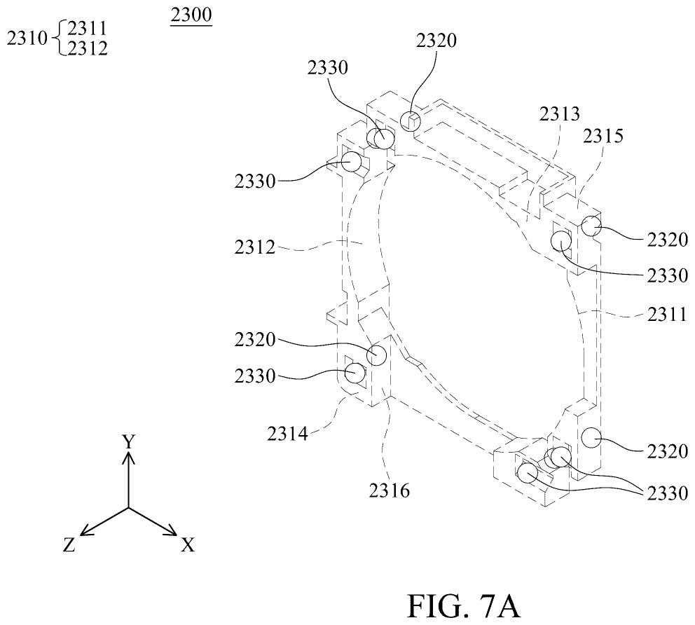

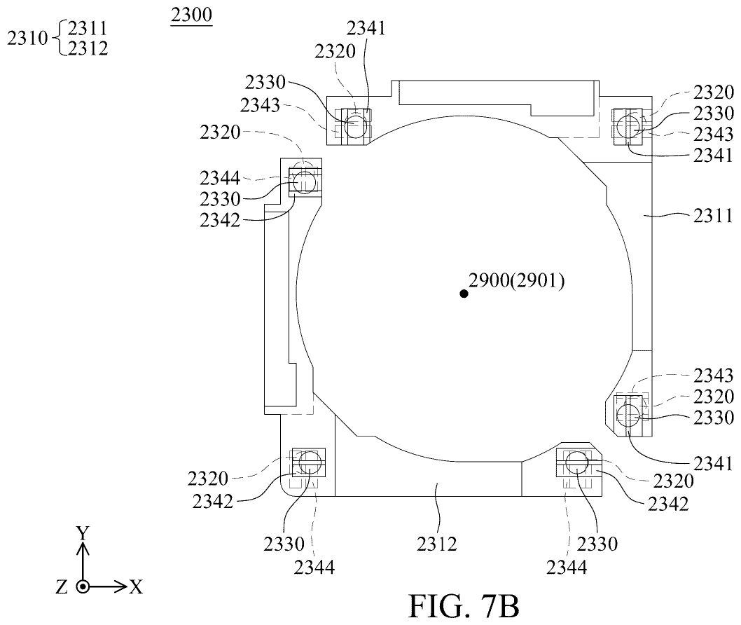

FIG. 7A is a schematic view of the connecting assembly 2300, and FIG. 7B is a top view of the connecting assembly 2300. As shown in FIGS. 7A and 7B, the connecting assembly 2300 may include a first connecting element 2310, a second connecting element 2320, and a third connecting element 2330. The first connecting element 2310 may include a first portion 2311 and a second portion 2312. As shown in FIG. 6B, when viewed along the main axis 2900, the first portion 2311 and the second portion 2312 may be separated from each other and located on opposite sides of the second reference axis 2912. In addition, as shown in FIGS. 4D, 4E, and 7A, the first portion 2311 may have a first surface 2313 and a third surface 2315, while the second portion 2312 may have a second surface 2314 and a fourth surface 2316. The first surface 2313 and the second surface 2314 may face the same direction (such as facing the +Z direction), and the third surface 2315 and the fourth surface 2316 may face the same direction (such as facing the −Z direction), and the first surface 2313 and the third surface 2315 (or the second surface 2314 and the fourth surface 2316) may face opposite directions.

A plurality of first guide recesses 2341 may be provided on the first surface 2313, a plurality of second guide recesses 2342 may be provided on the second surface 2314, a plurality of third guide recesses 2343 may be provided on the third surface 2315, and a plurality of fourth guide recesses 2344 may be provided on the fourth surface 2316. The first guide recesses 2341 and the fourth guide recesses 2344 may extend in the same direction, and the second guide recesses 2342 and the third guide recesses 2343 may extend in the same direction, and the extending direction of the first guide recesses 2341 and the fourth guide recesses 2344 may be different from the extending direction of the second guide recesses 2342 and the third guide recesses 2343. For example, the first guide recesses 2341 and the fourth guide recesses 2344 may extend along a direction parallel to the Y axis (the third axis), and the second guide recesses 2342 and the third guide recesses 2343 may extend along a direction parallel to the X axis (the fourth axis), and the third axis and the fourth axis are perpendicular to each other. That is, in the direction facing the first movable portion 2210, the extending direction of the first guide recesses 2341 on the first portion 2311 is different from the extending direction of the second guide recesses 2342 on the second portion 2312. In the direction facing the second movable portion 2220, the extending direction of the third guide recesses 2343 on the first portion 2311 is different from the extending direction of the fourth guide recesses 2344 on the second portion 2312. Accordingly, the first portion 2311 and the second portion 2312 may move relative to the first movable portion 2210 and the second movable portion 2220 in the XY plane to achieve optical image stabilization.

In some embodiments, the second connecting element 2320 may be disposed in the second guide recesses 2342 and the fourth guide recesses 2344, and the third connecting element 2330 may be disposed in the first guide recesses 2341 and the third guide recesses 2343. The second connecting element 2320 may be, for example, a sphere that simultaneously contacts the first connecting element 2310 and the second movable portion 2220, and the third connecting element 2330 may be, for example, a sphere that simultaneously contacts the first connecting element 2310 and the first movable portion 2210, so as to reduce friction between the first connecting element 2310 and the first movable portion 2210 and the second movable portion 2220, thereby reducing friction when the first movable portion 2210 moves relative to the second movable portion 2220. In some embodiments, as shown in FIG. 7B, when viewed along the main axis 2900, each first guide recess 2341 may at least partially overlap with another third guide recess 2343, and each second guide recess 2342 may at least partially overlap with another fourth guide recess 2344. In some embodiments, as shown in FIG. 6B, when viewed along the main axis 2900, the first coil 2411, the second coil 2412, the third coil 2413, the fourth coil 2414, and the fifth coil 2415 do not overlap with the connecting assembly 2300. Accordingly, the size of the optical element driving mechanism 2000 in the Z axis direction may be reduced to achieve miniaturization.

In summary, the embodiments of the present disclosure provide an optical element driving mechanism, including a fixed portion, a movable assembly, and a driving assembly. The movable assembly is movably connected to the fixed portion, and the driving assembly is used to drive the movable assembly to move relative to the fixed portion. Accordingly, functions such as auto focus and zoom can be achieved, and miniaturization can also be accomplished.

The relative positions and size relationship of the elements in the present disclosure may allow the driving mechanism achieving miniaturization in specific directions or for the entire mechanism. Moreover, different optical modules may be combined with the driving mechanism to further enhance optical quality, such as the quality of photographing or accuracy of depth detection. Therefore, the optical modules may be further utilized to achieve multiple anti-vibration systems, so image stabilization may be significantly improved.

Although embodiments of the present disclosure and their advantages already have been described in detail, it should be understood that various changes, substitutions and alterations may be made herein without departing from the spirit and the scope of the disclosure as defined by the appended claims. Moreover, the scope of the present application is not intended to be limited to the particular embodiments of the process, machine, manufacture, and composition of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are also intended to include within their scope of such processes, machines, manufacture, and compositions of matter, means, methods, or steps. In addition, each claim herein constitutes a separate embodiment, and the combination of various claims and embodiments are also within the scope of the disclosure.

What is claimed is:

1. An optical element driving mechanism, comprising:
a fixed portion;
a movable assembly movably connected to the fixed portion; and
a driving assembly used for driving the movable assembly to move relative to the fixed portion.

2. The optical element driving mechanism as claimed in claim 1, wherein:
the driving assembly is disposed between the fixed portion and the movable assembly;
the fixed portion comprises a case and a bottom arranged along a main axis;
the movable assembly comprises a first movable portion movably connected to the fixed portion and including a first opening;
when viewed along the main axis, the first opening comprises:
a first opening side having a linear shape and extending along a first direction;
a second opening side having a linear shape and extending along a second direction;
a third opening side having a linear shape and extending along a third direction; and
a fourth opening side having a linear shape and extending along a fourth direction;
the first direction is different from the second direction;
the first direction is parallel to the third direction;
the first direction is different from the fourth direction;
the second direction is parallel to the fourth direction.

3. The optical element driving mechanism as claimed in claim 2, wherein:
the main axis passes through a center of the optical element driving mechanism;
in a top view, a first reference axis and a second reference axis intersect at the center;
the first reference axis extends along a first axis;
the second reference axis extends along a second axis;
the first axis and the second axis are perpendicular to each other;
in the top view, the first reference axis and the second reference axis divide the top view into four quadrants, the four quadrants being, in a counterclockwise order, a first quadrant, a second quadrant, a third quadrant, and a fourth quadrant;
the first opening side is located in the first quadrant;
the second opening side is located in the second quadrant;
the third opening side is located in the third quadrant;
the fourth opening side is located in the fourth quadrant; and
when viewed along the main axis, the first reference axis and the second reference axis do not pass through the first opening side, the second opening side, the third opening side, or the fourth opening side.

4. The optical element driving mechanism as claimed in claim 3, wherein:
the movable assembly further comprises a second movable portion movably connected to the fixed portion and including a second opening;
the optical element driving mechanism further comprises:
a connecting assembly disposed between the first movable portion and the second movable portion, and the connecting assembly comprising:
a first connecting element;
a second connecting element disposed on the first connecting element and movably connected to the first movable portion; and
a third connecting element disposed on the first connecting element and movably connected to the second movable portion;
a first connecting portion disposed on the fixed portion; and
a second connecting portion disposed on the fixed portion.

5. The optical element driving mechanism as claimed in claim 4, wherein:
the first direction is perpendicular to the second direction;
the first direction is perpendicular to the fourth direction;
the first connecting portion extends along the main axis;
the second connecting portion extends along the main axis;
the bottom comprises a side, and the first connecting portion and the second connecting portion are arranged along a direction parallel to the side;
the first movable portion has a plurality of recesses located on the first opening side, the second opening side, the third opening side, and the fourth opening side;
each of the recesses comprises a first portion extending along the main axis;
when viewed along the main axis, the first portion is exposed to the first movable portion.

6. The optical element driving mechanism as claimed in claim 5, wherein:
the driving assembly comprises:
a first coil disposed between the fixed portion and the first movable portion;
a first magnetic element disposed between the fixed portion and the first movable portion, and corresponding to the first coil;
a second coil disposed between the fixed portion and the first movable portion;
a second magnetic element disposed between the fixed portion and the first movable portion, and corresponding to the second coil;
a third coil disposed between the fixed portion and the first movable portion; and
a third magnetic element disposed between the fixed portion and the first movable portion, and corresponding to the third coil;
the first coil and the second coil are located on different sides of the first movable portion;
the first coil and the third coil are located on different sides of the first movable portion; and
the second coil and the third coil are located on the same side of the first movable portion.

7. The optical element driving mechanism as claimed in claim 6, wherein:
the second movable portion comprises a second opening;
when viewed along the main axis, the second opening comprises:
a fifth opening side having a linear shape and extending along the first direction;
a sixth opening side having a linear shape and extending along the second direction;
a seventh opening side having a linear shape and extending along the third direction; and
an eighth opening side having a linear shape and extending along the fourth direction;
the fifth opening side is located in the first quadrant;
the sixth opening side is located in the second quadrant;
the seventh opening side is located in the third quadrant;
the eighth opening side is located in the fourth quadrant.

8. The optical element driving mechanism as claimed in claim 7, wherein:
when viewed along the main axis, a minimum distance between the first opening side and the center is different from a minimum distance between the fifth opening side and the center;
when viewed along the main axis, a minimum distance between the second opening side and the center is different from a minimum distance between the sixth opening side and the center;
when viewed along the main axis, a minimum distance between the third opening side and the center is different from a minimum distance between the seventh opening side and the center;
when viewed along the main axis, a minimum distance between the fourth opening side and the center is different from a minimum distance between the eighth opening side and the center;
when viewed along the main axis, the first reference axis and the second reference axis do not pass through the fifth opening side, the sixth opening side, the seventh opening side, or the eighth opening side;
the first connecting portion is disposed between the fixed portion and the second movable portion;
the second connecting portion is disposed between the fixed portion and the second movable portion; and
the second reference axis is parallel to the side.

9. The optical element driving mechanism as claimed in claim 8, wherein:
when viewed along the main axis, the first opening further comprises:
a first connecting side having an arcuate shape and connecting the first opening side and the second opening side;
a second connecting side having an arcuate shape and connecting the second opening side and the third opening side;
a third connecting side having an arcuate shape and connecting the third opening side and the fourth opening side; and
a fourth connecting side having an arcuate shape and connecting the fourth opening side and the first opening side;
when viewed along the main axis, the first opening side has a first length;
when viewed along the main axis, the fifth opening side has a second length;
the first length and the second length are different.

10. The optical element driving mechanism as claimed in claim 9, wherein:
the first connecting portion comprises:
a first connecting unit having a spherical shape;
a second connecting unit having a spherical shape;
a third connecting unit having a spherical shape; and
a fourth connecting unit having a spherical shape;
the first connecting unit, the second connecting unit, the third connecting unit, and the fourth connecting unit are sequentially arranged along the main axis;
a size of the first connecting unit is greater than a size of the second connecting unit;
the size of the first connecting unit is greater than a size of the third connecting unit;
the size of the second connecting unit is smaller than a size of the fourth connecting unit; and
the size of the third connecting unit is smaller than the size of the fourth connecting unit.

11. The optical element driving mechanism as claimed in claim 10, wherein:
when viewed along the main axis, the second opening surrounds the first opening;
the first length is smaller than the second length;
when viewed along the main axis, the minimum distance between the first opening side and the center is smaller than the minimum distance between the fifth opening side and the center;
when viewed along the main axis, the minimum distance between the second opening side and the center is smaller than the minimum distance between the sixth opening side and the center;
when viewed along the main axis, the minimum distance between the third opening side and the center is smaller than the minimum distance between the seventh opening side and the center;
when viewed along the main axis, the minimum distance between the fourth opening side and the center is smaller than the minimum distance between the eighth opening side and the center.

12. The optical element driving mechanism as claimed in claim 11, wherein:
the first connecting element has a connecting element side having a linear shape;
the fifth opening side is located between the first opening side and the connecting element side;
the connecting element side is parallel to the first opening side;
when viewed along the main axis, the second opening further comprises:
a fifth connecting side having an arcuate shape and connecting the fifth opening side and the sixth opening side;
a sixth connecting side having an arcuate shape and connecting the sixth opening side and the seventh opening side;
a seventh connecting side having an arcuate shape and connecting the seventh opening side and the eighth opening side; and
an eighth connecting side having an arcuate shape and connecting the eighth opening side and the fifth opening side.

13. The optical element driving mechanism as claimed in claim 12, wherein:
when viewed along the main axis, a reference circle is defined with the center as a circle center and tangent to the fifth connecting side, the sixth connecting side, the seventh connecting side, and the eighth connecting side;
when viewed along the main axis, the reference circle and the connecting assembly at least partially overlap with each other;
in the first quadrant, the first connecting element is at least partially located between the reference circle and the first opening;
in the first quadrant, the first connecting element is at least partially located between the reference circle and the second opening;
in the first quadrant, the second connecting element is at least partially located between the reference circle and the first opening;
in the first quadrant, the second connecting element is at least partially located between the reference circle and the second opening.

14. The optical element driving mechanism as claimed in claim 13, wherein:
in the second quadrant, the connecting assembly is not located between the reference circle and the second opening;
in the third quadrant, the connecting assembly is not located between the reference circle and the second opening;
in the fourth quadrant, the connecting assembly is not located between the reference circle and the second opening;
when viewed along the main axis, the reference circle passes between the third connecting element and the sixth opening side; and
the connecting element side is at least partially located within the reference circle.

15. The optical element driving mechanism as claimed in claim 8, wherein:
each of the recesses further comprises a second portion and a third portion;
the second portion is located between the first portion and the third portion and connects the first portion and the third portion;
the first portion and the third portion extend in the same direction;
an extending direction of the first portion and the third portion is different from an extending direction of the second portion;
in a direction along which the main axis extends, the first portion and the third portion do not overlap with each other.

16. The optical element driving mechanism as claimed in claim 15, wherein:
when viewed in a direction perpendicular to the main axis, the first portion, the second portion, and the third portion are exposed to the first movable portion;
the connecting assembly further comprises a fourth connecting element disposed on the first connecting element and movably connected to the first movable portion and the second movable portion; and
the second connecting element, the third connecting element, and the fourth connecting element directly contact the first movable portion and the second movable portion.

17. The optical element driving mechanism as claimed in claim 6, wherein:
the driving assembly further comprises:
a fourth coil disposed between the fixed portion and the first movable portion;
a fourth magnetic element disposed between the fixed portion and the first movable portion corresponding to the fourth coil;
a fifth coil disposed between the fixed portion and the first movable portion; and
a fifth magnetic element disposed between the fixed portion and the first movable portion corresponding to the fifth coil;
the first coil and the fourth coil are disposed on different sides of the first movable portion;
the second coil and the fourth coil are disposed on different sides of the first movable portion;
the fourth coil and the fifth coil are disposed on the same side of the first movable portion.

18. The optical element driving mechanism as claimed in claim 17, wherein:
when viewed along the main axis, the first reference axis does not pass through the first coil, the second coil, the third coil, the fourth coil, or the fifth coil;
when viewed along the main axis, the first reference axis does not pass through the first magnetic element, the second magnetic element, the third magnetic element, the fourth magnetic element, or the fifth magnetic element;
when viewed along the main axis, the first magnetic element is located between the first coil and the first opening side;
when viewed along the main axis, the second magnetic element is located between the second coil and the second opening side;
when viewed along the main axis, the third magnetic element is located between the third coil and the second opening side;
when viewed along the main axis, the fourth magnetic element is located between the fourth coil and the third opening side; and
when viewed along the main axis, the fifth magnetic element is located between the fifth coil and the third opening side.

19. The optical element driving mechanism as claimed in claim 18, wherein:
the first connecting element comprises a first portion and a second portion;
when viewed along the main axis, the first portion and the second portion are located on opposite sides of the second reference axis;
the first portion comprises a first surface;
the second portion comprises a second surface facing the same direction as the first surface;
a first guide recess is provided on the first surface and extends along a direction parallel to a third axis;
a second guide recess is provided on the second surface and extends along a direction parallel to a fourth axis;
an extending direction of the third axis is different from an extending direction of the fourth axis;
when viewed along the main axis, the first coil and the connecting assembly do not overlap each other;
when viewed along the main axis, the second coil and the connecting assembly do not overlap each other;
when viewed along the main axis, the third coil and the connecting assembly do not overlap each other;
when viewed along the main axis, the fourth coil and the connecting assembly do not overlap each other; and
when viewed along the main axis, the fifth coil and the connecting assembly do not overlap each other.

20. The optical element driving mechanism as claimed in claim 19, wherein:
when viewed along the main axis, the first portion and the second portion are separated from each other;
the third axis and the fourth axis are perpendicular;
the first portion further comprises a third surface;
the second portion further comprises a fourth surface facing the same direction as the third surface;
the first surface and the third surface face opposite directions;
a third guide recess is provided on the third surface and extends along a direction parallel to the fourth axis;
a fourth guide recess is provided on the fourth surface and extends along a direction parallel to the third axis;
when viewed along the main axis, the first guide recess and the third guide recess at least partially overlap with each other; and
when viewed along the main axis, the second guide recess and the fourth guide recess at least partially overlap with each other.
